(19) United States
(12) Patent Application Publication
(10) Pub. No.: US 2021/0051923 A1
(43) Pub. Date: Feb. 25, 2021

(54) DOG FECES COLLECTION CONTAINER

(71) Applicants: Geum Ja Ham, Incheon (KR); Ji Su An, Incheon (KR); Ji Youl An, Incheon (KR)

(72) Inventors: Geum Ja Ham, Incheon (KR); Ji Su An, Incheon (KR); Ji Youl An, Incheon (KR)

(21) Appl. No.: 16/998,424

(22) Filed: Aug. 20, 2020

(30) Foreign Application Priority Data
Aug. 21, 2019 (KR) 10-2019-0102409

(51) Int. Cl. A01K 23/00; B65F 1/06

(52) U.S. Cl. CPC A01K 23/005; B65F 2230/134; B65F 1/06

(57) ABSTRACT

The present invention provides a dog feces collection container including a first case (20) having a feces collection aid embedded therein and a second case (30) coupled to the first case (20) and in which a feces collection space portion configured to hold feces is disposed, wherein an upper support pin (UP) and a lower support pin (LP) are disposed inside the first case (20), the feces collection aid is provided as a roll product that is wound in a roll shape, and the roll product wound in a roll shape is fitted to the upper support pin (UP) and the lower support pin and embedded in the first case (20).

### CROSS-REFERENCE TO RELATED APPLICATION

This application claims priority to and the benefit of Korean Patent Application No. 2019-0102409, filed on Aug. 21, 2019, the disclosure of which is incorporated herein by reference in its entirety.

### BACKGROUND

### 1. Field of the Invention

The present invention relates to a dog feces collection container, and more particularly, to a dog feces collection container with a new configuration that allows a user to cleanly put dog feces therein when a dog defecates and dispose of the dog feces.

### 2. Discussion of Related Art

Various types of pets, such as dogs and cats, are raised at home as a hobby or as companions. Particularly, people with dogs often take their dogs with them when they take a walk in a park or go out. People with dogs can be found easily in parks or streets.

While people with dogs take a walk in a park or on a street, the dogs may defecate directly on a trail or street. Dog feces are harmful to the environment and may give an unsanitary impression and cause discomfort to others. Thus, in order to prevent dogs from defecating directly on the ground in public places, such as on a trail or street, there is a need to appropriately receive dog feces using a separate bag or container and dispose of the dog feces at another place. In recent years, in some public places such as parks, dog owners are obliged to receive and dispose of dog feces on their own.

Thus, people who take a walk in a park or on a street with their dogs put dog feces in an appropriate collection means, such as a separate plastic bag, and dispose of the dog feces on their own. The most common way to collect dog feces is to carry a disposable plastic bag and tissue paper and, when pets defecate, wrap the feces with the tissue paper and put the feces in the plastic bag by hand.

However, when people with dogs carry a plastic bag holding dog feces with them in a state in which the feces are visible to the outside, not only is it not good in appearance, but it is also hygienically undesirable, and a foul smell of the feces may cause discomfort.

### RELATED ART DOCUMENTS

### Patent Documents

(Patent Document 0001) Korean Utility Model Registration No. 20-0397105 Date of Registration: Sep. 22, 2005)

(Patent Document 0002) Korean Patent Registration No. 10-0843589 (Date of Registration: Jun. 27, 2008)

(Patent Document 0003) Korean Patent Registration No. 10-1748035 (Date of Registration: Jun. 9, 2017)

### SUMMARY OF THE INVENTION

The present invention is directed to providing a dog feces collection container with a new configuration that is hygienically desirable and allows a user to cleanly put dog feces therein when a dog defecates and dispose of the dog feces.

According to the present invention, there is provided a dog feces collection container including a first case having a feces collection aid embedded therein and a second case coupled to the first case and in which a feces collection space portion configured to hold feces is disposed.

An upper support pin and a lower support pin may be disposed inside the first case, the feces collection aid may be provided as a roll product that is wound in a roll shape, and the roll product wound in a roll shape may be fitted to the upper support pin and the lower support pin and embedded in the first case.

The first case may include a case body having an open portion disposed at an upper end portion and a cap coupled to the case body to open or close the open portion disposed at the upper end portion of the case body.

The cap may be coupled to the case body by a screw portion.

A ring may be disposed at a lower end portion of the case body.

A ring may be disposed on the cap.

An upper support pin and a lower support pin which face each other may be disposed inside the cap and the case body, respectively.

The first case may be configured so that the cap is coupled to the case body, and a withdrawal hole may be disposed in the case body to communicate with inner and outer surfaces thereof. The second case may be configured to be interchangeably coupled to an upper portion and a lower portion of the first case by a detaching means.

The lower portion of the first case may be a portion of the case body where the ring is present, and the upper portion of the first case may be a portion that corresponds to the cap coupled to the case body. The second case may be configured to be coupled to the lower portion of the first case or coupled to the upper portion of the first case where the cap is present.

The second case may include a flexible tube portion, and the flexible tube portion may allow the second case to be extended and used.

The second case may include a guide sleeve coupled to an inner portion thereof, and the guide sleeve may be coupled to the first case to allow the second case to slide from the guide sleeve and be extended and used.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exploded perspective view of a dog feces collection container according to the present invention;

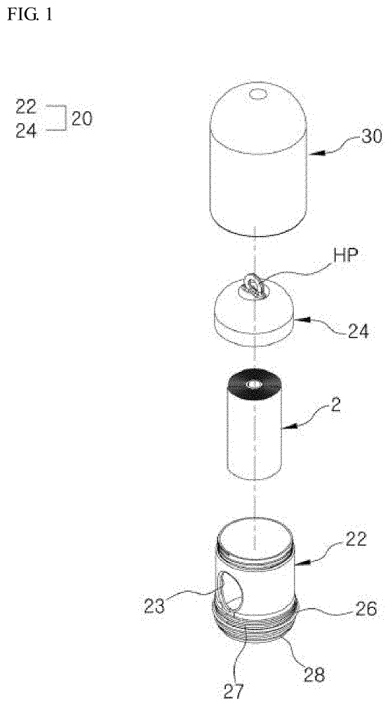

FIG. 2 is a perspective view of an exterior of the dog feces collection container according to the present invention;

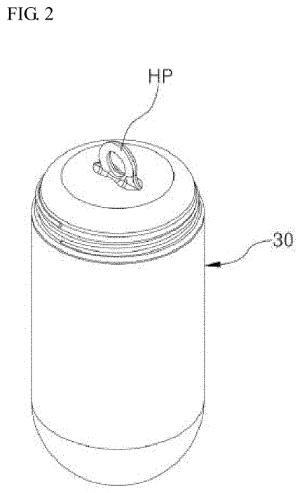

FIG. 3 is a cross-sectional view showing an internal structure of FIG. 2;

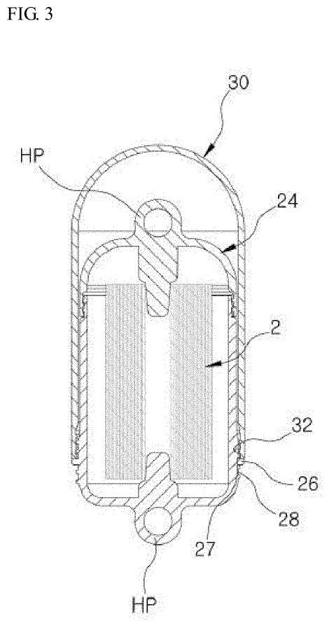

FIG. 4 is a perspective view showing a state in which a second case is flipped upside down and coupled to a first case to collect dog feces using the dog feces collection container illustrated in FIG. 2;

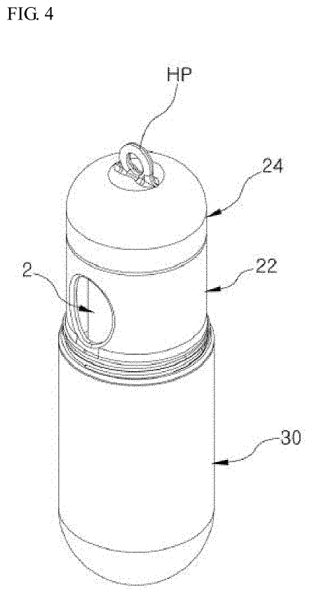

FIG. 5 is a cross-sectional view of FIG. 4;

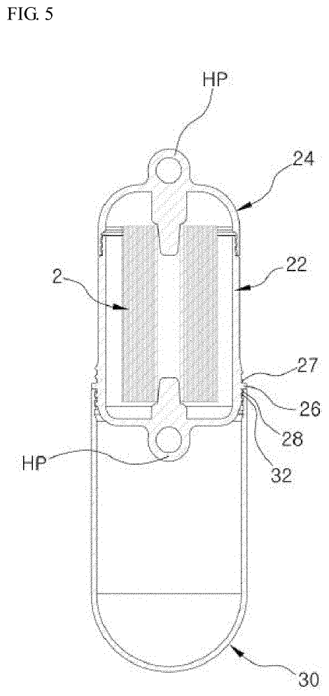

FIG. 6 is a perspective view of a dog feces collection container according to another embodiment of the present invention;

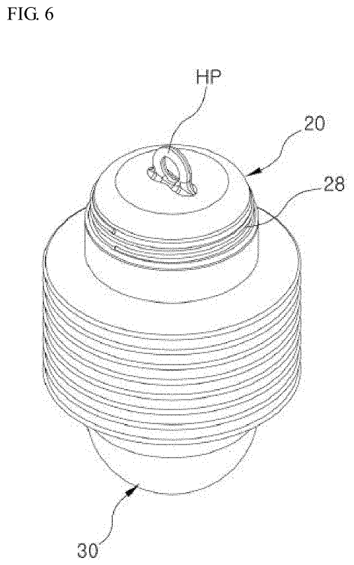

FIG. 7 is a cross-sectional view showing an internal structure of FIG. 6;

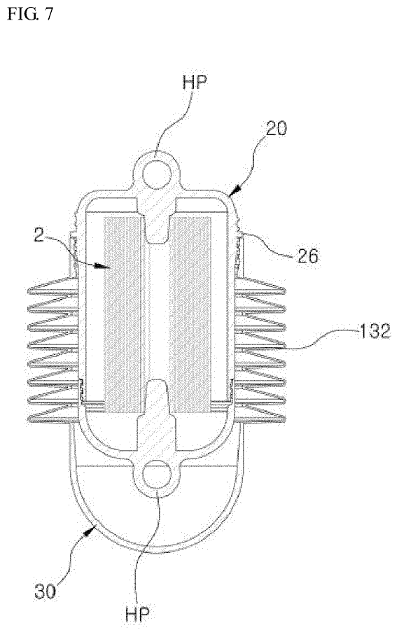

FIG. 8 is a perspective view showing a state in which a second case is flipped upside down and coupled to a first case and a length of the second case is extended to collect dog feces using the dog feces collection container illustrated in FIG. 6;

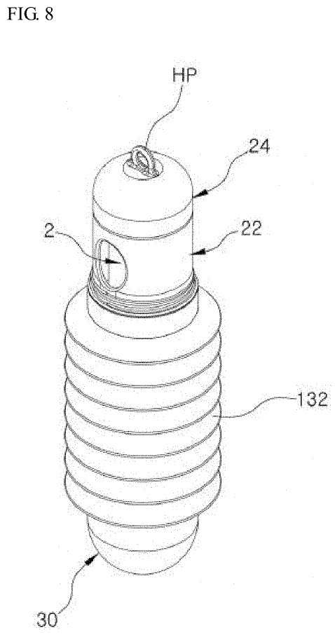

FIG. 9 is a cross-sectional view of FIG. 8;

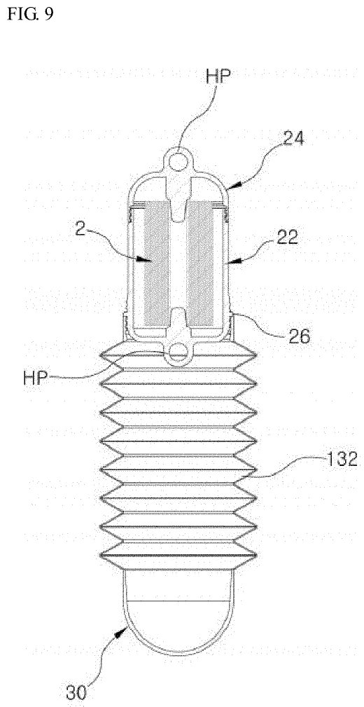

FIG. 10 is a perspective view of a dog feces collection container according to yet another embodiment of the present invention;

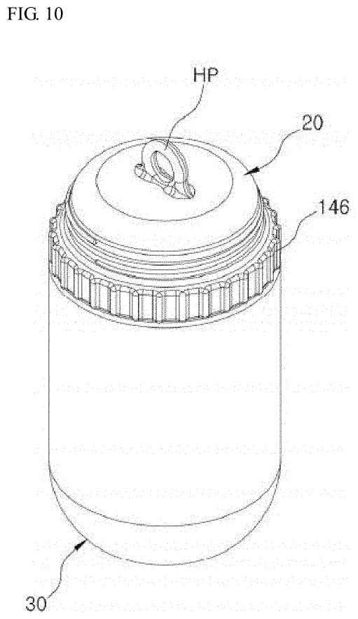

FIG. 11 is a cross-sectional view showing an internal structure of FIG. 10;

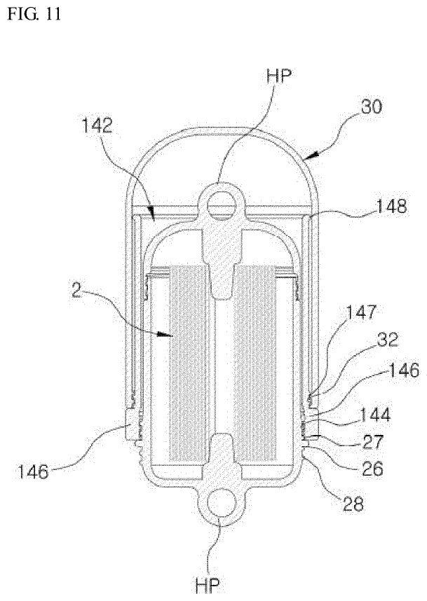

FIG. 12 is a cross-sectional view showing a state in which a second case is flipped upside down and coupled to a first case to collect dog feces using the dog feces collection container illustrated in FIG. 10;

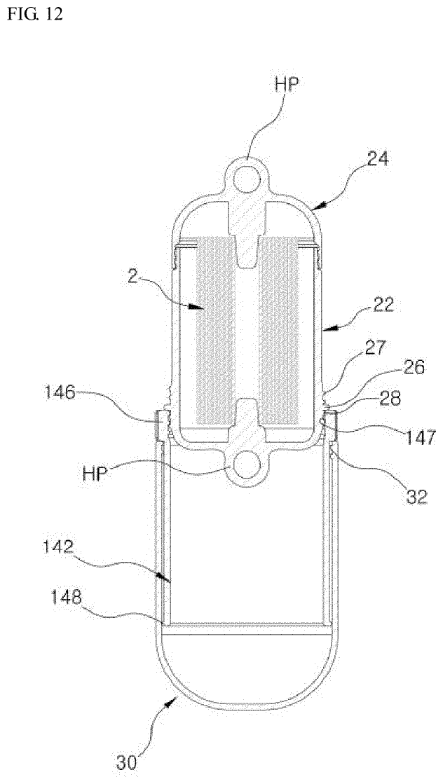

FIG. 13 is a perspective view showing a state in which a length of the second case is extended in the dog feces collection container illustrated in FIG. 12; and

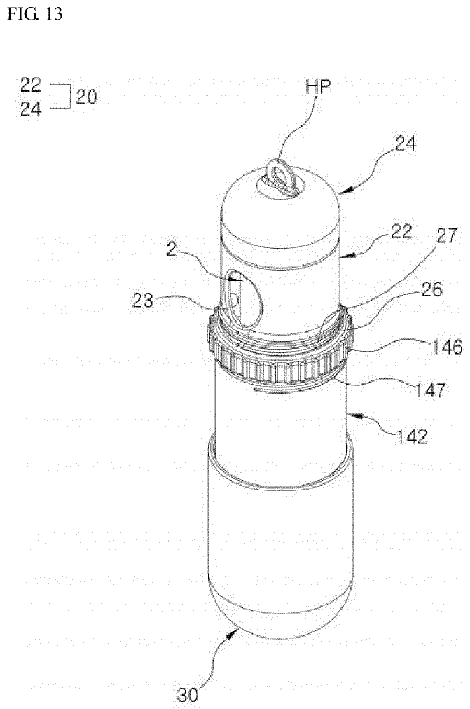

FIG. 14 is a cross-sectional view of FIG. 13.

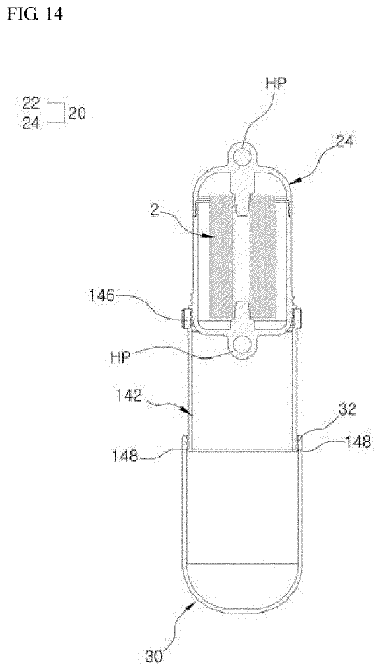

### DETAILED DESCRIPTION OF EXEMPLARY EMBODIMENTS

Hereinafter, exemplary embodiments of the present invention will be described in detail with reference to the accompanying drawings. The objects, features and advantages of the present invention will become more apparent by referring to the accompanying drawings and the detailed description below. Also, in describing the present invention, when detailed description of a related known configuration or function is deemed to obscure the gist of the present invention, the detailed description thereof will be omitted.

In addition, in describing the elements of the present invention, terms such as first, second, A, B, (a), and (b) may be used. Such terms are only used for the purpose of distinguishing one element from another element, and the essence, order, or sequence of the corresponding element is not limited by the terms. For example, when a certain element is described as being “connected,” “coupled,” or “linked” to another element, this may mean that the element is directly connected or linked to the other element but may also mean that the element is “connected,” “coupled,” or “linked” to the other element via another element therebetween.

Referring to the drawings, a dog feces collection container according to the present invention includes a first case 20 having a feces collection aid embedded therein and a second case 30 coupled to the first case 20 and in which a feces collection space portion configured to hold feces is disposed. In the present invention, the feces collection aid refers to a roll product that is wound in a roll shape. In most cases, the roll product may be a plastic bag roll 2 that is wound in a roll shape. According to circumstances, the roll product may also be a tissue paper roll that is wound in a roll shape. Hereinafter, for convenience of description, the roll product will be referred to as a “plastic bag roll 2.”

### First Embodiment

The first case 20 is configured so that a cap 24 is coupled to a case body 22.

The case body 22 is formed in a tubular shape having an open portion disposed at an upper end portion. The case body 22 has a cylindrical shape. A screw portion is disposed at an outer circumferential surface of the upper end portion of the case body 22. A screw portion is also disposed at an outer circumferential surface of a lower end portion of the case body 22. Here, the screw portion at the lower end portion of the case body 22 is divided into an upper screw portion 27 and a lower screw portion 28 with respect to a boundary stepped portion 26. Screw thread directions of the upper screw portion 27 and the lower screw portion 28 are opposite directions with respect to the boundary stepped portion 26. For example, when the first case 20 is stood upright and viewed from one side, the screw thread direction of a screw portion below the boundary stepped portion 26 may be a clockwise direction, and the screw thread direction of a screw portion above the boundary stepped portion 26 may be a counterclockwise direction.

A withdrawal hole 23 is disposed in the case body 22 to communicate with inner and outer surfaces thereof. The withdrawal hole 23 is in the shape of a circular hole.

The open portion at the upper end portion of the case body 22 is opened or closed by the cap 24. A screw portion is disposed at an inner circumferential surface of a lower end portion of the cap 24 and, as the screw portion of the cap 24 is coupled to the screw portion at the outer circumferential surface of the upper end portion of the case body 22, the cap 24 is detachably coupled to the case body 22 by the screw portion. When the cap 24 is opened with respect to the screw portion, the open portion at the upper end portion of the case body 22 is opened, and when the cap 24 is coupled to the case body 22 with respect to the screw portion, the open portion at the upper end portion of the case body 22 is closed due to the cap 24.

A ring HP is disposed at a lower end portion of the case body 22. The ring HP is integrally connected to the lower end portion of the case body 22.

The ring HP is also disposed at an upper end portion of the cap 24. The ring HP is also integrally connected to the upper end portion of the cap 24.

The first case 20 is configured so that the cap 24 is coupled to the case body 22 and has a structure in which the ring HP is disposed at each of the upper end portion and the lower end portion of the first case 20. That is, the first case 20 has a structure in which the ring HP is disposed at the upper end portion and the lower end portion and the withdrawal hole 23 is formed to communicate with inner and outer surfaces thereof.

A lower support pin LP is disposed at an inner bottom portion of the case body 22 and an upper support pin UP is disposed at an inner upper surface of the cap 24 so that a pair of the upper support pin UP and the lower support pin LP which face each other is disposed inside the first case 20. Here, a spacing protrusion which protrudes to the side is further disposed at the upper support pin UP and the lower support pin LP.

A plastic bag roll 2 is embedded inside the first case 20. A bobbin portion which is disposed at the center of the plastic bag roll 2 is fitted to the upper support pin UP and the lower support pin LP inside the first case 20. The cap 24 is opened from the case body 22, the plastic bag roll 2 is embedded inside the case body 22, the bobbin portion at the center of a lower end portion of the plastic bag roll is fitted to the lower support in LP disposed at the bottom portion of the case body 22, the cap 24 is coupled back to the case body 22, and the upper support pin UP disposed at the inner upper portion of the cap 24 is fitted to the bobbin portion at the center of an upper end portion of the plastic bag roll 2. In this way, the plastic bag roll 2 may be embedded inside the first case 20. Here, since the spacing protrusion protruding to the side is further disposed at the upper support pin UP and the lower support pin LP, the upper end portion and the lower end portion of the plastic bag roll 2 remain spaced apart at a predetermined distance from the upper surface of the cap 24 and the bottom portion of the case body 22, respectively.

The second case 30 is formed in a tubular shape having an open portion disposed at one end portion. The second case 30 has a cylindrical shape. An inner diameter of the second case 30 is greater than an outer diameter of the first case 20. A screw portion 32 is disposed at an inner circumferential surface adjacent to the end portion of the second case 30 where the open portion is disposed.

The second case 30 is screw-coupled to the first case 20. In a state in which the second case 30 is fitted to cover the first case 20, the screw portion 32 at the inner circumferential surface of the second case 30 is coupled to the upper screw portion 27 which is defined with respect to the boundary stepped portion 26 of the first case 20. In this way, the second case 30 is screw-coupled to the first case 20. In the state in which the second case 30 is coupled to the upper screw portion 27, which is at the outer circumferential surface of the lower portion of the first case 20, by the screw portion 32 at the inner circumferential surface, the first case 20 is covered down to the cap 24 and an upper portion of the boundary stepped portion 26 by the second case 30.

Meanwhile, the second case 30 is configured so that the second case 30 may be flipped upside down and coupled to the lower end portion of the first case 20 by the screw portion 32. In a state in which the second case 30 is flipped upside down such that the open portion at the one end portion of the second case 30 is at the top, the screw portion 32 at the inner circumferential surface of the second case 30 is coupled to the lower screw portion 28 which is disposed below the boundary stepped portion 26 of the first case 20. In this way, the second case 30 which has been removed from the first case 20 and flipped upside down may be coupled to the first case 20. When the second case 30 which is flipped upside down is coupled to the lower portion of the first case 20, a feces collection space portion configured to hold collected feces is secured between the lower portion of the first case 20 and the second case 30.

The process of collecting dog feces using the dog feces collection container according to the present invention is as follows.

In a state in which the second case 30 is coupled to the first case 20 such that the ring HP disposed at the lower end portion of the first case 20 is exposed to the outside and most of the remaining portions and the cap 24 of the first case 20 are covered by the second case 30, the second case 30 is unfastened and separated from the first case 20 when it is necessary to collect dog feces. In a state in which the second case 30 is coupled to the first case 20 such that the ring HP disposed at the lower end portion of the first case 20 is exposed to the outside and the first case 20 is covered down to the cap 24 and the upper portion of the boundary stepped portion 26, which is disposed at the first case 20, by the second case 30, the second case 30 is unfastened and separated from the first case 20 when it is necessary to collect dog feces.

In a state in which the second case 30 is separated from the first case 20, the withdrawal hole 23 of the first case 20 is exposed, and a single plastic bag is torn off the plastic bag roll 2, which is embedded in the first case 20, and obtained through the withdrawal hole 23. The plastic bag unrolled from the plastic bag roll 2 may be withdrawn to the outside of the first case 20 through the withdrawal hole 23 of the first case 20. Here, since the plastic bag roll 2 has perforated lines, plastic bags, which are unrolled from the plastic bag roll 2 and withdrawn through the withdrawal hole 23 of the first case 20, may be easily torn off one at a time due to the perforated lines.

Dog feces are put in the plastic bag which is taken out through the withdrawal hole 23 of the first case 20 and torn off, the plastic bag holding the dog feces is put in the second case 30 separated from the first case 20, and the second case 30 is coupled to the first case 20. The screw portion 32 at the inner circumferential surface of the second case 30 is coupled to the lower screw portion 28 which is disposed below the boundary stepped portion 26 of the first case 20. The plastic bag holding the dog feces is put in the feces collection space portion secured between the lower portion of the first case 20 and the second case 30.

As described above, dog feces are collected through the process in which the second case 30 is separated from the upper portion of the first case 20, the plastic bag holding the dog feces is put in the second case 30, and then the second case 30 is coupled to the lower portion of the first case 20.

### Second Embodiment

The second embodiment of the present invention is similar to the first embodiment in terms of a structure of a first case 20 but is different from the first embodiment in that a second case 30 includes a flexible tube portion 132. That is, the second embodiment is different from the first embodiment in that the second case 30 includes the flexible tube portion 132 and the flexible tube portion 132 allows the second case 30 to be extended and used.

A length of the second case 30 is relatively shorter in a state in which the flexible tube portion 132 is compressed, and the length of the second case 30 is relatively longer in a state in which the flexible tube portion 132 is extended. In a state in which the length of the second case 30 is extended by the flexible tube portion 132, a feces collection space portion inside the second case 30 becomes larger.

The second embodiment is similar to the first embodiment in that dog feces are collected through the process in which, in a state in which a cap 24 of the first case 20 is covered by the second case 30, the second case 30 is unfastened from the first case 20, dog feces are put in a plastic bag, the plastic bag holding the dog feces is put in the second case 30, and then the second case 30 is coupled to a lower portion of the first case 20.

The length of the second case 30 may be extendable by the flexible tube portion 132. The length of the second case 30 may be extended when the flexible tube portion 132 is pulled and extended. When the flexible tube portion 132 is pulled and the length of the second case 30 is extended, the size of the space portion inside the second case 30 that is configured to hold feces may be expanded.

### Third Embodiment

The third embodiment of the present invention is similar to the first embodiment in terms of a structure of a first case 20 but is different from the first embodiment in that a guide sleeve 142 is coupled to an inner portion of a second case 30 and the guide sleeve 142 is coupled to the first case 20 to allow the second case 30 to slide along the guide sleeve 142 and be extended and used.

A screw portion 144 is disposed at an inner circumferential surface of a lower end portion of the guide sleeve 142. The guide sleeve 142 has a tubular shape of which an upper end portion and a lower end portion are open. A thickness extension portion 146 is disposed at an outer circumferential surface of the guide sleeve 142 that is adjacent to the lower end portion thereof, and the thickness extension portion 146 allows a stepped portion to be formed on an outer circumferential surface of the lower end portion of the guide sleeve 142.

An outer screw portion 147 is disposed at an outer circumferential surface of the guide sleeve 142 that is disposed above the stepped portion. The guide sleeve 142 has a structure in which the outer screw portion 147 is disposed at the outer circumferential surface between the stepped portion, which is formed due to the thickness extension portion 146, and the upper end portion. Also, an extension catching protrusion 148 is disposed at an outer circumferential surface of the guide sleeve 142 that is adjacent to the upper end portion. The extension catching protrusion 148 is formed in the shape of a protrusion that protrudes from the outer circumferential surface of the guide sleeve 142.

As the screw portion 144 at the inner circumferential surface of the lower end portion of the guide sleeve 142 is coupled to a screw portion disposed at an outer circumferential surface of the first case 20, the guide sleeve 142 is coupled to the outer circumferential surface of the first case 20. In a state in which the screw portion 144 at the inner circumferential surface of the guide sleeve 142 is coupled to an upper screw portion 27, which is disposed between a boundary stepped portion 26 and an upper end portion of the first case 20, a cap 24 and most of the outer circumferential surface of the first case 20 are covered by the guide sleeve 142 and the second case 30.

As a screw portion 32 at an inner circumferential surface of the second case 30 is coupled to the outer screw portion 147 at the outer circumferential surface of the guide sleeve 142, the second case 30 is coupled to cover the outer circumferential surface of the guide sleeve 142. When the screw portion 32 at the inner circumferential surface of the second case 30 is coupled to the outer screw portion 147 at the outer circumferential surface of the guide sleeve 142 in a state in which the screw portion 144 at the inner circumferential surface of the guide sleeve 142 is coupled to the upper screw portion 27 which is disposed between the boundary stepped portion 26 and the upper end portion of the first case 20, the guide sleeve 142 and the second case 30 are sequentially disposed at the outer circumferential surface of the first case 20.

In the third embodiment, dog feces are collected through the process in which, in a state in which the cap 24 of the first case 20 is covered by the guide sleeve 142 and the second case 30, the guide sleeve 142 is unfastened from the first case 20, dog feces are put in a plastic bag, the plastic bag holding the dog feces is put in the guide sleeve 142 at the inner side of the second case 30, and then the guide sleeve 142 is coupled to a lower portion of the first case 20.

The guide sleeve 142 and the second case 30 are flipped upside down such that the lower end portions of the guide sleeve 142 and the second case 30 are at the top, and the screw portion 144 at the inner circumferential surface of the guide sleeve 142 is coupled to a lower screw portion 28 which is disposed at an outer circumferential surface of the first case 20 that is below the boundary stepped portion 26. In this way, dog feces may be put in an inner feces collection space portion, which is disposed between the lower portion of the first case 20 and the second case 30, and be disposed of.

Here, the second case 30 may be slid from the guide sleeve 142 to increase the size of the feces collection space portion which is disposed between the lower portion of the first case 20 and the second case 30. When the second case 30 is slid from the guide sleeve 142 in a direction moving away from the lower portion of the first case 20, the feces collection space portion becomes larger by as much as a space portion inside the guide sleeve 142, and thus the inner feces collection space portion between the lower portion of the first case 20 and the second case 30 may become larger. Meanwhile, in a state in which the second case 30 is slid from the guide sleeve 142 such that the size of the feces collection space portion is increased, the screw portion 32 at the inner circumferential surface of the second case 30 is caught at an extension support protrusion 138 disposed at the outer circumferential surface of the guide sleeve 142, and thus the second case 30 is not detached from the guide sleeve 142. Therefore, the state in which the size of the inner feces collection space portion between the lower portion of the first case 20 and the second case 30 is increased may be maintained.

Accordingly, the dog feces collection container according to the present invention allows dog feces to be carried in the collection container instead of being carried in a plastic bag and being visible to the outside. Not only is it good in appearance, but it is also hygienically desirable. It is good in appearance and sanitary because dog feces may be carried in the feces collection space portion between the first case 20 and the second case 30. Also, since dog feces are put in the dog feces collection container so as not to be visible to the outside, discomfort caused by a foul smell of the feces may be relieved to some extent.

Also, according the present invention, since the ring HP is disposed at the lower end portion of the first case 20, a user may put his or her finger in the ring HP at the lower end portion of the first case 20 or hang the ring HP on an appropriate hook and carry the dog feces collection container in a state in which the first case 20 is covered down to the cap 24 and the upper portion of the boundary stepped portion 26 by the second case 30. Thus, it is convenient to carry the dog feces collection container.

In addition, the user may put his or her finger in the ring HP disposed at the cap 24 or hang the ring HP on an appropriate hook and carry the dog feces collection container even in a state in which dog feces are put in the feces collection space portion between the first case 20 and the second case 30. Thus, it is convenient to carry the dog feces collection container even after dog feces are collected.

In addition, according to the present invention, the plastic bag roll is embedded in the first case 20 and the plastic bags are taken out through the withdrawal hole 23 and used one at a time. Since the upper end portion and the lower end portion of the plastic bag roll are spaced a predetermined distance apart from the inner bottom portion of the first case 20 and the inner upper surface of the cap 24 by the spacing protrusions at the upper and lower portions, the plastic bag roll rotates smoothly about the upper support pin UP and the lower support pin LP when the plastic bags are being taken out through the withdrawal hole 23 of the first case 20. Thus, it is convenient to take out the plastic bags through the withdrawal hole 23 of the first case 20. Portions at which the upper end portion and the lower end portion of the plastic bag roll 2 come in contact with the inner bottom portion of the first case 20 and the inner upper surface of the cap 24 are minimized by the spacing protrusions at the upper and lower portions, and the plastic bag roll 2 rotates smoothly about the upper support pin UP and the lower support pin LP when the plastic bags are being taken out through the withdrawal hole 23 of the first case. Therefore, it is convenient to take the plastic bags out through the withdrawal hole 23 of the first case 20.

Meanwhile, according to the second embodiment, the length of the second case 30 may be extended by the flexible tube portion 132 and a relatively larger amount of feces may be collected. Most large dogs defecate in larger amounts than small dogs. When the amount of dog feces is relatively large, the length of the second case 30 may be extended by the flexible tube portion 132 so that the amount of feces that may be put in the second case 30 increases by as much as the extended length of the second case 30. Thus, dog feces may be collected without any problems regardless of the amount of dog feces.

Also, according to the third embodiment, when the second case 30 is pulled and slid from the guide sleeve 142, the size of the inner feces collection space portion between the lower portion of the first case 20 and the second case 30 is increased due to the guide sleeve 142 and the second case 30. Thus, a relatively larger amount of feces may be collected. Most large dogs defecate in larger amounts than small dogs. When the amount of dog feces is relatively large, the second case 30 may be pulled from the guide sleeve 142 so that the amount of feces that may be put in the second case 30 increases by as much as an increase in the size of the feces collection space portion that corresponds to an increase in the size of the space portion inside the guide sleeve 142. Thus, even according to the third embodiment, dog feces may be collected without any problems regardless of the amount of dog feces.

The present invention allows dog feces to be carried without being visible to the outside, and thus it is hygienically desirable. Also, the present invention makes it relatively convenient to dispose of dog feces after the dog feces are collected.

Of course, the present invention has various advantageous effects in addition to the above advantageous effects, but the above advantageous effects can be said to correspond to the major advantageous effects of the present invention.

Specific embodiments of the present invention have been described above. However, the idea and scope of the present invention are not limited by the embodiments, and those of ordinary skill in the art to which the present invention pertains should understand that various modifications and changes are possible within the scope not departing from the gist of the present invention.

The embodiments described herein are only provided to completely inform those of ordinary skill in the art to which the present invention pertains of the scope of the invention. Thus, the embodiments should be understood as illustrative, rather than limiting, in all aspects. The present invention is defined only by the scope of the claims.

What is claimed is:

1. A dog feces collection container comprising:
a first case (20) having a feces collection aid embedded therein; and
a second case (30) coupled to the first case (20) and in which a feces collection space portion configured to hold feces is disposed.

2. The dog feces collection container of claim 1, wherein an upper support pin (UP) and a lower support pin (LP) are disposed inside the first case (20), the feces collection aid is provided as a roll product that is wound in a roll shape, and the roll product wound in a roll shape is fitted to the upper support pin (UP) and the lower support pin and embedded in the first case (20).

3. The dog feces collection container of claim 1, wherein the first case (20) includes:
a case body (22) having an open portion disposed at an upper end portion; and
a cap (24) coupled to the case body (22) to open or close the open portion disposed at the upper end portion of the case body (22).

4. The dog feces collection container of claim 3, wherein the cap (24) is coupled to the case body (22) by a screw portion.

5. The dog feces collection container of claim 1, wherein a ring (HP) is disposed at a lower end portion of the case body (22).

6. The dog feces collection container of claim 5, wherein a ring (HP) is disposed on the cap (24).

7. The dog feces collection container of claim 3, wherein an upper support pin (UP) and a lower support pin which face each other are disposed inside the cap (24) and the case body (22), respectively.

8. The dog feces collection container of claim 1, wherein the first case (20) is configured so that the cap (24) is coupled to the case body (22), and a withdrawal hole (23) is disposed in the case body (22) to communicate with inner and outer surfaces thereof.

9. The dog feces collection container of claim 1, wherein the second case (30) is configured to be interchangeably coupled to an upper portion and a lower portion of the first case (20) by a detaching means.

10. The dog feces collection container of claim 9, wherein the lower portion of the first case (20) is a portion of the case body (22) where the ring (HP) is present, the upper portion of the first case (20) is a portion that corresponds to the cap (24) coupled to the case body (22), and the second case (30) is configured to be coupled to the lower portion of the first case (20) or coupled to the upper portion of the first case (20) where the cap (24) is present.

11. The dog feces collection container of claim 1, wherein the second case (30) includes a flexible tube portion (132), and the flexible tube portion (132) allows the second case (30) to be extended and used.

12. The dog feces collection container of claim 1, wherein the second case (30) includes a guide sleeve (142) coupled to an inner portion thereof, and the guide sleeve (142) is coupled to the first case (20) to allow the second case (30) to slide from the guide sleeve (142) and be extended and used.
